(19) United States
(12) Patent Application Publication
(10) Pub. No.: US 2018/0218471 A1
(43) Pub. Date: Aug. 2, 2018

(54) SYSTEMS AND METHODS FOR DISPLAYING AN ITEM IN A SELECTED STORAGE LOCATION USING AUGMENTED REALITY

(71) Applicant: Wal-Mart Stores, Inc., Bentonville, AR (US)

(72) Inventor: Michael Scott Stengel, Centerton, AR (US)

(21) Appl. No.: 15/882,658

(22) Filed: Jan. 29, 2018

Related U.S. Application Data
(60) Provisional application No. 62/453,787, filed on Feb. 2, 2017.

(51) Int. Cl. G06Q 90/00; G06K 9/78; G06K 9/00; G06T 7/60; G06Q 10/08; G06T 7/70; G06F 17/30

(52) U.S. Cl. CPC G06Q 90/00; G06K 9/78; G06K 9/00671; G06T 7/60; G06T 2207/30232; G06T 7/70; G06K 9/00771; G06F 17/30964; G06Q 10/087

(57) ABSTRACT

A system for determining storage locations for one or more physical items in a facility is discussed. The system includes a first mobile user device configured to execute a dimension analysis module to obtain dimensions of one or more physical items and to capture one or more images of the facility. The system further includes a computing system configured to execute an optimization module that when executed receives dimensions of the one or more physical items from the first mobile user device and generates one or more recommended locations for storage of the one or more physical items. The optimization module further transmits the recommended storage locations to the first mobile user device. The mobile user device provides an augmented reality display of the physical items at the recommended storage locations within a depiction of the facility created using the images.

### CROSS-REFERENCE TO RELATED PATENT APPLICATIONS

This application claims priority to U.S. Provisional Application No. 62/453,787 filed on Feb. 2, 2017, the content of which is hereby incorporated by reference in its entirety.

### BACKGROUND

Facilities that store or sell products must first place the products on storage and/or display shelves. Facilities expend time and effort in considering where and how to place the products on the storage/display shelves. With finite shelving areas, efforts are made to allocate the products to the shelves so as to minimize shelf-stocking labor and maximize availability.

### BRIEF SUMMARY

In one embodiment, a system for determining storage locations for one or more physical items in a facility and displaying the physical items in a storage location using augmented reality is provided. The system includes a first mobile user device including a display and a camera. The first mobile user device is configured to execute a dimension analysis module to obtain dimensions of the physical items and to capture one or more images of the facility. The system also includes a database including dimensions of multiple storage locations in the facility and a master item list including an arrangement of physical items in the storage locations. The system further includes a computing system communicatively coupled to the database and the first mobile user device. The computing system is configured to execute an optimization module that when executed receives dimensions of the physical items from the first mobile user device. The optimization module when executed also determines one or more available storage locations for the physical items based on the master item list, the dimensions of the physical items, and the dimensions of the storage locations. The optimization module when executed further generates one or more recommended locations for storage of the physical items based on the determination of the available storage locations and pre-defined criteria. The optimization module when executed further transmits the recommended storage locations to the first mobile user device which provides an augmented reality display of the physical items at the recommended storage locations within a depiction of the facility created using the images.

In another embodiment, a computer-implemented method for determining storage locations for one or more physical items in a facility and displaying the physical items in a storage location using augmented reality is provided. The method includes obtaining, with a first mobile user device that includes a display and a camera, dimensions of one or more physical items and capturing one or more images of the facility. The method also includes receiving, at a computing system the dimensions of the physical items from the first mobile user device, the computing system communicatively coupled to a database that holds dimensions of multiple storage locations in the facility and a master item list including an arrangement of physical items in the storage locations. The method further includes determining one or more available storage locations for the physical items with the computing system, the determining based on the master item list, the dimensions of the physical items and the dimensions of the storage locations. The method also includes generating one or more recommended locations for storage of the physical items with the computing system, the generating based on the determination of the available storage locations and pre-defined criteria. The method further includes transmitting the recommended locations from the computing system to the first mobile user device. The mobile user device provides an augmented reality display of the physical items at the recommended locations within a depiction of the facility created using the images.

A system for sharing storage locations for one or more physical items in a facility is provided. The system includes a first mobile user device including a display and a camera. The first mobile user device is configured to capture one or more images of the facility. The system also includes a second mobile user device including a second display and a second camera. The second mobile user device is configured to capture one or more additional images of the facility. The system further includes a computing system communicatively coupled to the first mobile user device and the second mobile user device. The computing system is configured to execute an optimization module that receives a request for a storage location for one or more first physical items from the first mobile user device. The first physical items have a first dimension. The optimization module also receives a request for a storage location for one or more second physical items from the second mobile user device. The second physical items have a second dimension. The optimization module further generates one or more recommended locations for storage of the first physical items. The optimization module also transmits the recommended locations for storage of the first physical items to the first mobile user device. The first mobile user device provides an augmented reality display of the first physical items at the recommended storage locations within a depiction of the facility created using the images. The optimization module further receives a rejection of the recommended locations for storage from the first mobile user device and determines that the first dimensions of the first physical items are substantially similar to the second dimensions of the second physical items. The optimization module when executed further transmits the recommended locations for storage to the second mobile user device which provides an augmented reality display of the second physical items at the recommended storage locations within a depiction of the facility created using the additional images.

### BRIEF DESCRIPTION OF DRAWINGS

To assist those of skill in the art in making and using a storage location determination system and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIG. 1 illustrates an exemplary network environment suitable for a computer-based system for virtually displaying one or more physical items in a storage location using augmented reality, in accordance with an exemplary embodiment;

FIG. 2 illustrates an exemplary method for determining one or more storage locations for one or more physical items, in accordance with an exemplary embodiment;

FIG. 3 illustrates an exemplary method for selecting a storage location for one or more physical items using a mobile user device, in accordance with an exemplary embodiment; and

FIG. 4 illustrates an exemplary computing system, in accordance with an exemplary embodiment.

### DETAILED DESCRIPTION

Described in detail herein are methods and systems for determining a storage location for one or more physical items in a facility. The system includes a mobile user device including a display and a camera. The mobile user device is configured to execute a dimension analysis module to obtain dimensions of one or more physical items by scanning the one or more physical items. The mobile user device is further configured to capture one or more images of the facility using the camera.

The system further includes a computing system communicatively coupled to an inventory database and the mobile user device. The inventory database includes dimensions of physical items, dimensions of multiple storage locations in the facility, and an arrangement of physical items in the storage locations. The computing system is configured to execute an optimization module that receives dimensions of one or more physical items from the mobile user device. The optimization module may be an application or other executable code and is configured to determine one or more available storage locations for the physical items based on the dimensions of the physical items, the dimensions of the available storage locations, and the arrangement of physical items in the storage locations. The optimization module generates one or more recommended storage locations for the physical items based on a determination of the available storage locations and pre-defined criteria described below. The computing system transmits the recommended storage locations to the mobile user device. The mobile user device provides an augmented reality display of the physical items at the recommended storage locations within a depiction of the facility created using the one or more images.

In additional embodiments, the mobile user device is a first mobile user device and the computing system is further communicatively coupled to one or more second mobile user devices. The computing system is further configured to receive an acceptance or a rejection of at least one recommended storage location from the first mobile user device. If a recommended storage location is accepted by the first mobile user device, the computing system inserts in the inventory database that the one or more physical items were stored into the accepted recommended storage location. If at least one recommended storage location is rejected by the first mobile user device, the computing system transmits the rejected recommended storage location(s) to the second mobile user devices searching for a similar available storage location to store a physical item.

The methods and systems described herein provide benefits including, but not limited to, space consolidation and savings, reduction in time needed to select storage spaces, improved orientation of physical items in storage spaces, identification of additional storage spaces, and reduced labor and inventory costs.

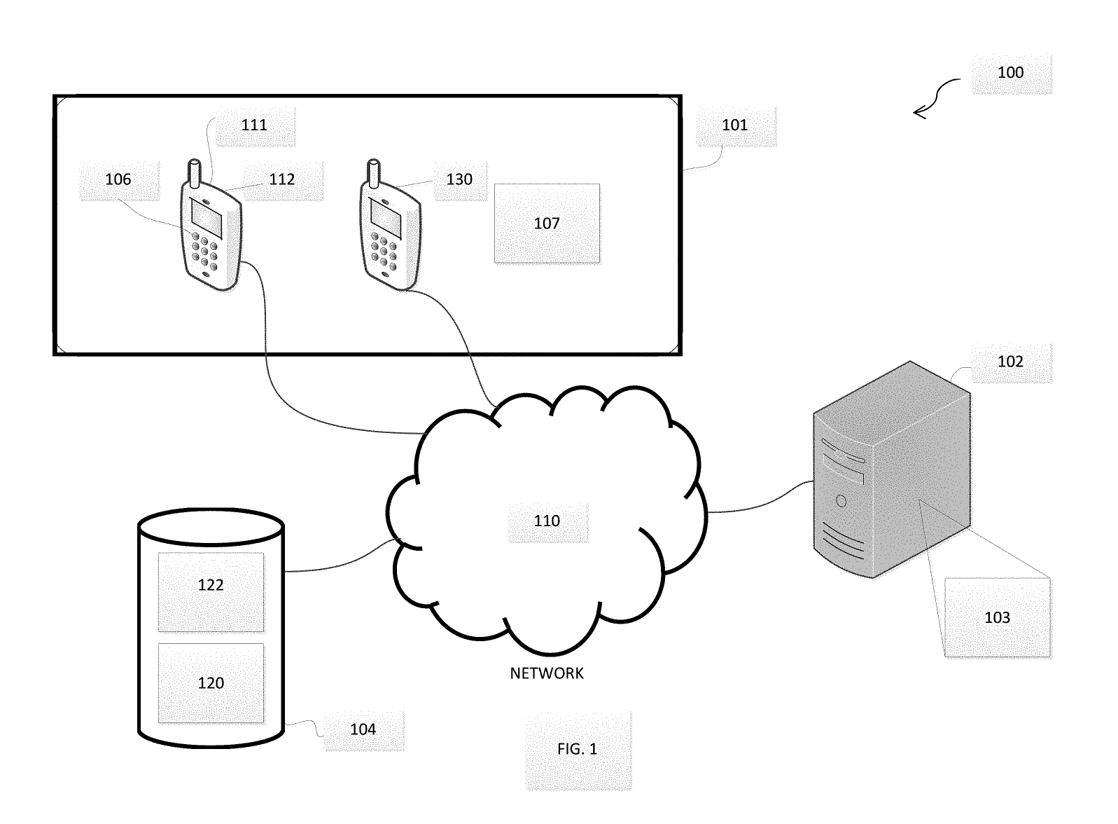

FIG. 1 illustrates an exemplary network environment suitable for a computer-based system 100 for virtually displaying one or more physical items in a storage location using augmented reality, in accordance with an exemplary embodiment. System 100 includes at least one computing system 102 (one shown in FIG. 1), at least one inventory database 104 (one shown in FIG. 1), at least one mobile user device 106 (one shown in FIG. 1), and at least one physical item 107 (one shown in FIG. 1). Mobile user device 106 and physical item 107 are located within a facility 101. Mobile user device 106 is configured to communicate with computing system 102 via a communications network 110. In the exemplary embodiment, one or more portions of network 110 is an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In one embodiment, a user selects one or more physical items 107 for storage or display and initiates determining dimensions of one or more physical items 107. Mobile user device 106 is configured to execute a dimension analysis module 112 to obtain the dimensions of one or more physical items 107.

In one embodiment, each physical item 107 is associated with a machine-readable element. Dimension analysis module 112 may be an application or other code whose execution on mobile user device 106 utilizes a scanner configured to scan a machine-readable element associated with each physical item 107. The scanner may be a separate scanner in communication with mobile user device 106 and dimension analysis module 112. In another embodiment, the scanning capability may be provided by mobile user device 106. In one such embodiment, the machine-readable element includes identifiers containing the dimensions of associated physical item 107. The scanner scans the machine-readable element to obtain the dimensions of associated physical item 107. In another embodiment, the machine-readable element includes identifiers identifying each physical item 107. After the machine-readable element has been scanned and the identifier retrieved, dimension analysis module 112 transmits the identifier of scanned physical item 107 to computing system 102 and optimization module 103 via network 110. Optimization module 103 uses the identification of physical item 107 to retrieve the dimensions of physical item 107 from inventory database 104. In still another alternative embodiment, mobile user device 106 is configured to receive a manual input of the dimensions of physical item 107 via an interface provided by dimension analysis module 112 on mobile user device 106.

In an alternate embodiment, dimension analysis module 112 is an application or other executable process whose execution utilizes a scanner configured to scan the one or more physical items 107 and determines the dimensions of one or more physical items 107 using the scanned data. For example, the scanner may include a structure or depth sensor configured to determine dimensions of one or more physical items 107 by scanning each physical item 107 (using transmitted IR, lasers, etc.) and the dimension analysis module may generate a 3D model of each physical item 107 that includes a length, a width, and a height (i.e. the dimensions of the physical object) based on the scanned data.

In an exemplary embodiment, dimension analysis module 112 determines a length, a width, and a height of physical item 107. Upon obtaining the dimensions of physical item 107, mobile user device 106 transmits the dimensions of physical item 107 to computing system 102 and optimization module 103 via network 110.

In an embodiment, optimization module 103 may initiate the process of determining a storage location for physical item 107 by searching inventory database 104. Inventory database 104 is connected to optimization module 103 via network 110. Inventory database 104 can be located at one or more geographically distributed locations from computing system 102 and optimization module 103. Alternatively, inventory database 104 can be included within computing system 102.

In an exemplary embodiment, inventory database 104 includes a first database 120 and a second database 122. First database 120 stores item characteristics of multiple physical items. The item characteristics can be input by a user in a number of different manners, such as by computer-readable media or by a user via mouse and/or keyboard (not shown), and the like. Alternatively, item characteristics can be received from another source, such as from websites, another computer, a disc or other memory media, and the like. In the exemplary embodiment, first database 120 includes one or more columns for each physical item stored in first database 120. The one or more columns may include one or more of the following item characteristics for each physical item: product category information, a product description, physical item dimensions (e.g., a length, a width, and a height of a physical item), a weight, a product identification number, breakability, preferred physical item(s) as neighbor(s), avoided physical item(s) as neighbor(s), past storage location(s), and a frequency of usage (i.e., physical items that are used more frequently than others). In some embodiments, optimization module 103 determines a recommended storage location and/or an orientation of physical item 107 based at least in part upon the item characteristics stored in first database 120.

Second database 122 stores information regarding multiple storage locations. Second database 122 may include a length column, a width column, and a height column for each storage location. A storage locations may be identified by, for example, by numerical and/or alphabetical numbers including a row, column, shelf, area, etc., of the storage location in facility 101. Second database 122 may also include a weight column for a weight limit of a storage location. Second database 122 may include a known space allocation (i.e., a constraint affecting the permissible size of the resulting shelving assembly) including the amount of storage location available (e.g., in square feet) for each storage location. Second database 120 may include a master item list that includes an arrangement of physical items 107 in the storage locations. For example, the master inventory list specifies whether particular storage locations contain one or more physical items 107, and a location and an arrangement of physical items 107 stored in the storage locations within facility 101.

Optimization module 103 of computing system 102 may be configured to determine one or more available storage locations for one or more physical items 107 by mapping each physical item 107 to one or more unoccupied storage locations in facility 101. A storage location is an area of a floor or a shelf on which a physical item may be placed. The storage location can be any size, within physical dimensions and limits of facility 101. An available storage location is an unoccupied storage location with dimensions that are equal to or exceed the dimensions of a physical item 107 as determined above. Optimization module 103 selects available storage locations based on the dimensions of one or more physical items 107. For example, if a physical item 107 is generally large, then larger storage locations are selected. If physical item 107 is generally small, then smaller storage locations are selected.

Optimization module 103 calculates storage location dimensions required for one or more physical items 107 based upon area, stackability, and orientation of each physical item 107. In some embodiments, optimization module 103 performs a virtual storage process in a series of operations involving a number of comparisons of each physical item 107 to unoccupied storage locations. In some embodiments, optimization module 103 considers a physical item 107 to properly fit in an unoccupied storage location when the length, the width, and the height of physical item 107 is less than or equal to the length, the width and the height of the unoccupied storage location. If physical item 107 properly fits into the unoccupied storage location, the unoccupied storage location becomes an available storage location. For example, optimization module 103 may compare a height and a width of physical item 107 to an unoccupied space of a storage location with predefined height and width parameters. If the height and the width of physical item 107 do not exceed the height and width of the unoccupied storage location, the storage location becomes an available storage location.

Optimization module 103 is also configured to determine an orientation and/or an arrangement of each physical item 107 in unoccupied storage locations and/or available storage locations. In some embodiments, several iterations can be performed in which optimization module 103 stores physical item 107 in different orientations and/or positions in one or more storage locations in order to determine a storage efficiency of each storage location and/or orientation. Specifically, depending on a size and a shape of physical item 107, rearranging its orientation may save linear space on a shelf. For example, optimization module 103 determines a manner in which physical item 107 can be arranged or oriented in an efficient manner in one or more storage locations. In one embodiment, optimization module 103 may virtually rearrange items already in a storage location to determine optimal storage when determining recommended locations.

In an exemplary embodiment, the item characteristics stored in first database 120 are used to determine one or more recommended storage locations for one or more physical items 107 from the one or more available storage locations determined above. In different available storage locations, different item characteristics can determine the location and/or the manner in which one or more physical items 107 are stored. Accordingly, many different combinations of item characteristics can be employed as desired, including one or more (or even none) of the various item characteristics described above (e.g., length, depth, height, weight, vertical storability, stackability, neighbors, storage environment, etc.). For example, optimization module 103 may review first database 120 for item characteristics associated with a physical item 107 that optimization module 103 is attempting to store. First database 120 may include, for example, available storage locations within facility 101 where physical item 107 cannot be stored or other special storage requirements. Optimization module 103 is configured to take these special storage requirements based on the item characteristics into account when determining recommended storage locations. In one embodiment, optimization module 103 may also utilize historical sales and storage data in determining a priority of storage locations for physical items within a storage location.

Optimization module 103 and computing system 102 transmit the one or more recommended storage locations for each physical item 107 to mobile user device 106. The user then selects a recommended storage location for each physical item 107 from the one or more recommended storage locations shown on mobile user device 106. The selected storage locations occupied by each physical item 107 is subsequently updated in the corresponding storage location dimensions in second database 122.

In one embodiment, once a recommended storage location for a physical item 107 is selected, the user travels to the selected storage location with mobile user device 106. Mobile user device 106 includes an augmented reality (AR) application and uses camera 111 to capture images of facility 101, which are passed to the AR application. The AR application is configured to generate and display a virtual representation of physical item 107 at the selected storage location displayed via images captured by camera 111. The augmented reality application determines its location relative to the selected storage location using a location-based technology such as, but not limited to, geo-fencing, GPS, or Wi-Fi triangulation.

The virtual representation of physical item 107 is generated based on the obtained dimensions of physical item 107 and displayed on mobile user device 106 such that the user can view the display to determine a manner in which physical item 107 should be oriented or arranged in the storage location. The virtual representation of physical item 107 appears “embedded” into the real world environment of the selected storage location and facility 101 using images captured by the user's mobile device. In some embodiments, the user can be given the option of rearranging the orientation of the virtual depiction of physical item 107, such as by manually manipulating the virtual representation on the display.

In one embodiment, mobile user device 106 is a first mobile user device 106 and computing system 102 is further communicatively coupled to one or more second mobile user devices 130. The first and second mobile user devices each include a camera configured to capture one or more images of the facility and are configured to provide an augmented reality display of one or more physical items at one or more recommended storage locations within a depiction of the facility created using the images. As described above, optimization module 103 is configured to receive a request for a storage location for first physical items (i.e., one or more physical items 107) from first mobile user device 106. The first physical items have a first dimension. Optimization module 103 is further configured to receive a request for a storage location for one or more second physical items from at least one second mobile user device 130. The second physical items have a second dimension.

Optimization module 103 may be configured to generate one or more recommended locations for storage of the first physical items, and transmits the recommended locations for storage of the first physical items to first mobile user device 106. In turn, optimization module 103 receives from first mobile user device 106 an acceptance or rejection of a recommended storage location. If a recommended storage location is accepted, optimization module 103 inserts updates in second database 122 that the selected storage location is occupied by the first physical items.

Alternatively, when a recommended storage location is rejected, optimization module 103 determines whether the first dimensions of the first physical items are substantially similar to the second dimensions of the second physical items. If optimization module 103 determines that the dimensions are substantially similar, optimization module 103 transmits the recommended storage location to second mobile user device 130 searching for available storage locations to store the second physical items. Second mobile user device 130 can then accept or reject the recommended storage location. Second mobile user device 130 may provide an augmented reality display of the second physical items at the accepted recommended storage location within a depiction of the facility created using the images captured by the second mobile user device. In some embodiments, optimization module 103 determines whether to transmit the recommended storage location to the second mobile user device based on the item characteristics of the second physical items.

Once physical items 107 have been allocated to storage locations, optimization module 103 can repeat the space allocating process just described for additional physical items 107 selected to be stored. Optimization module 103 may then determine one or more arrangements of additional physical items 107 in recommended locations.

In one embodiment, dimension analysis module 112 utilizes a 3D scanner configured to capture one or more images of facility 101. The scanner is configured to determine dimensions of an environment of facility 101 by scanning the environment and generating a 3D map of storage locations of the environment. The dimensions of the storage locations are uploaded to second database 122 and used as described herein.

In another embodiment, optimization module 103 is configured to search for available storage locations within a predefined proximity to mobile user device 106. Optimization module 103 determines available storage locations for physical items 107 within a predefined proximity to mobile user device 106. Alternatively, optimization module 103 may determine that there are no storage locations for physical items 107 within the predefined proximity. As a result, optimization module 103 may then attempt to determine storage locations for physical items 107 outside the predefined proximity.

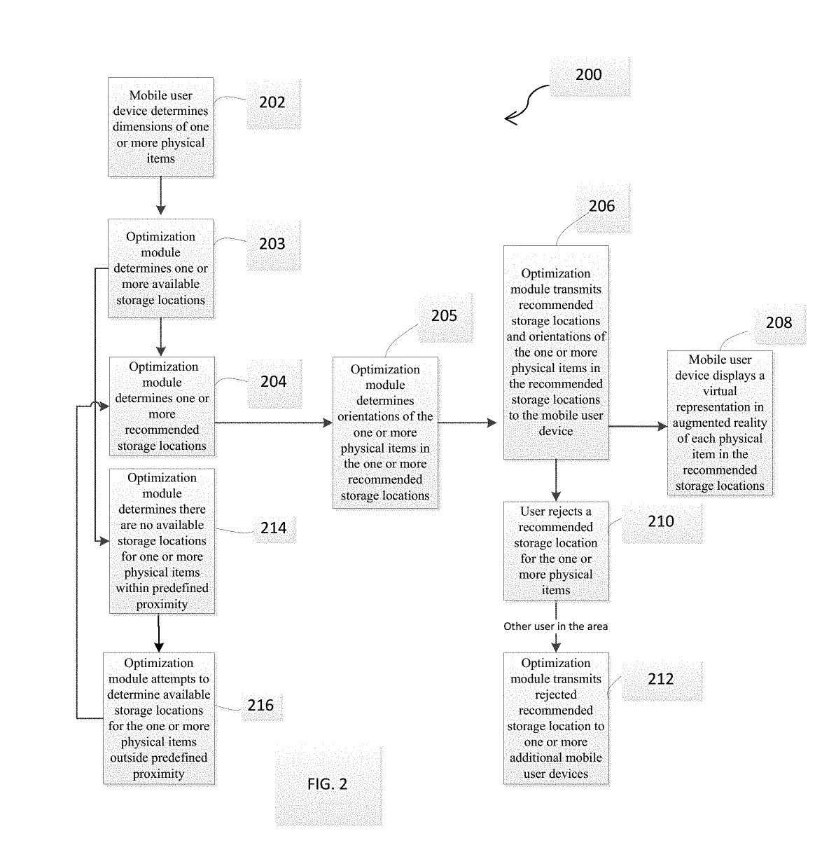

FIG. 2 illustrates an exemplary method 200 for determining a storage location for one or more physical items (i.e., one or more physical items 107 shown in FIG. 1). It will be appreciated that the method is programmatically performed, at least in part, by one or more computer-executable processes executing on, or in communication with one or more computing devices described further below. At operation 202, a mobile user device (i.e., mobile user device 106 shown in FIG. 1) determines dimensions of one or more physical items. For example, a user uses the mobile user device to scan a machine-readable element associated with a physical item. At operation 203, an optimization module (i.e., optimization module 103 shown in FIG. 1) determines one or more available storage locations for the one or more physical items. At operation 204, the optimization module determines one or more recommended storage locations for the one or more physical items. At operation 205, the optimization module determines orientations of the one or more physical items in the one or more recommended storage locations. At operation 206, the optimization module transmits the one or more recommended storage locations and the orientations of the one or more physical items in the one or more recommended storage locations to the mobile user device. At operation 208, the mobile user device displays a virtual representation in augmented reality of each physical item in the one or more recommended storage locations determined for that physical item. More specifically, the user is able to visualize the orientation of the virtual representation of the physical item in the storage location through the use of augmented reality.

Alternatively, at operation 210, the user rejects a recommended storage location for the one or more physical items using the mobile user device. At operation 212, the optimization module transmits the rejected recommended storage location to one or more additional mobile user devices searching for available storage locations to store one or more additional physical items.

In some embodiments, the optimization modules configured to search for available storage locations and/or recommended storage locations within a predefined proximity to the mobile user device. At operation 214, the optimization module determines that there are no available storage locations for the one or more physical items within a predefined proximity to the mobile user device. At operation 216, the optimization module attempts to determine one or more available storage locations for the one or more physical items outside the predefined proximity. If one or more available storage locations for the one or more physical items are found outside the predefined proximity, the optimization module attempts to determine one or more recommended storage locations as described above.

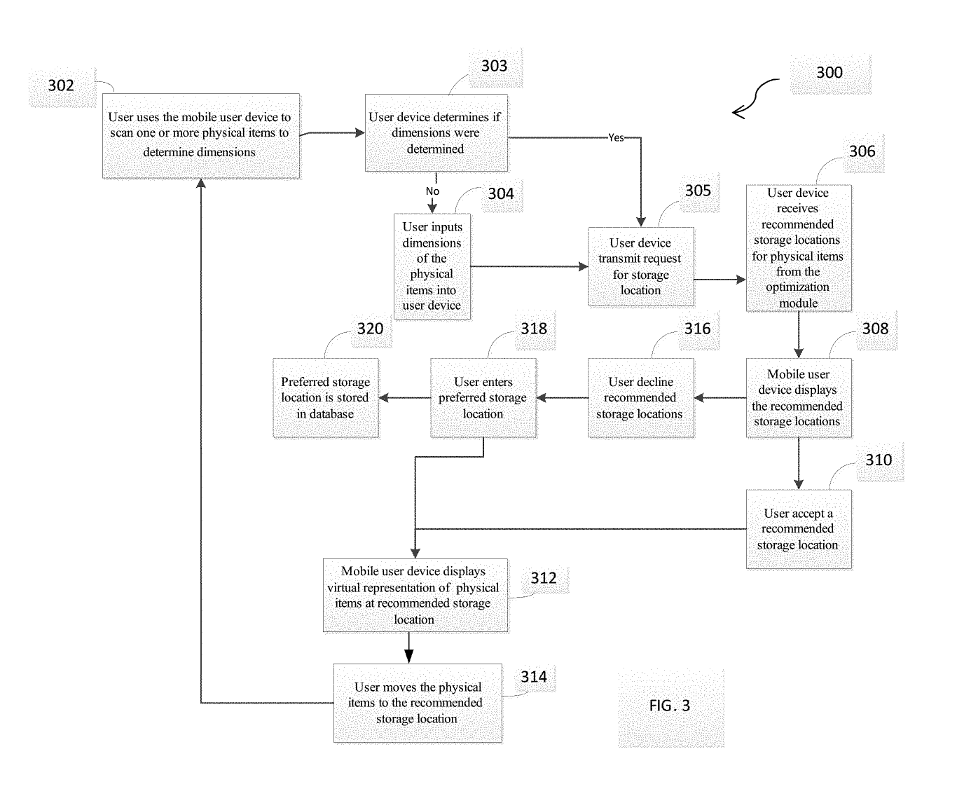

FIG. 3 illustrates an exemplary method 300 for determining and selecting a storage location for a physical item from among multiple recommended storage locations using a mobile user device (i.e., mobile user device 106 shown in FIG. 1). It will be appreciated that the method is programmatically performed, at least in part, by one or more computer-executable processes executing on, or in communication with one or more computing devices described further below. At operation 302, a user uses the mobile user device to scan one or more physical items to determine dimensions of the one or more physical items. For example, the mobile user device scans the one or more items using a scanner, as described above. At operation 303, the mobile user device determines whether the dimensions of the one or more physical items were successful determined. If the dimensions of the one or more physical items were not successful determined, at operation 304, the user inputs the dimensions of the one or more physical items into the mobile user device. At operation 305, the mobile user device transmits the dimensions of the one or more physical items and a request for a storage location for the one or more physical items to a computing system (i.e., computing system 102 shown in FIG. 1).

At operation 306, the mobile user device receives one or more recommended storage locations for the one or more physical items from the optimization module executing on the computing system. At operation 308, the mobile user device displays the one or more recommended storage locations. For example, the mobile user device may display a list of available storage locations enabling the user to accept or reject a storage location. At operation 310, the user accepts a storage location from the one or more recommended storage locations. At operation 312, the mobile user device displays a virtual representation of the one or more physical items at each recommended storage location of the one or more recommended storage locations. For example, the user may travel to the storage location and use a display on the mobile user device to view the virtual representation of the orientation and storage of the one or more physical items at a recommended storage location. In another embodiment recommended storage locations near the user may be presented in an augmented reality display without the user first selecting from a list. At operation 314, the user moves the one or more physical items to the recommended storage location in accordance with the augmented reality depiction.

Alternatively, at operation 316, the user declines the one or more storage locations on the mobile user device. At operation 318, the user enters a preferred storage location (such as a shelf number) into the mobile user device. At operation 320, the mobile user device displays an augmented reality depiction of the one or more physical items oriented and stored at the preferred storage location. At operation 320, the preferred storage location of the one or more physical items is stored in the first database as an item characteristic associated with the one or more physical items.

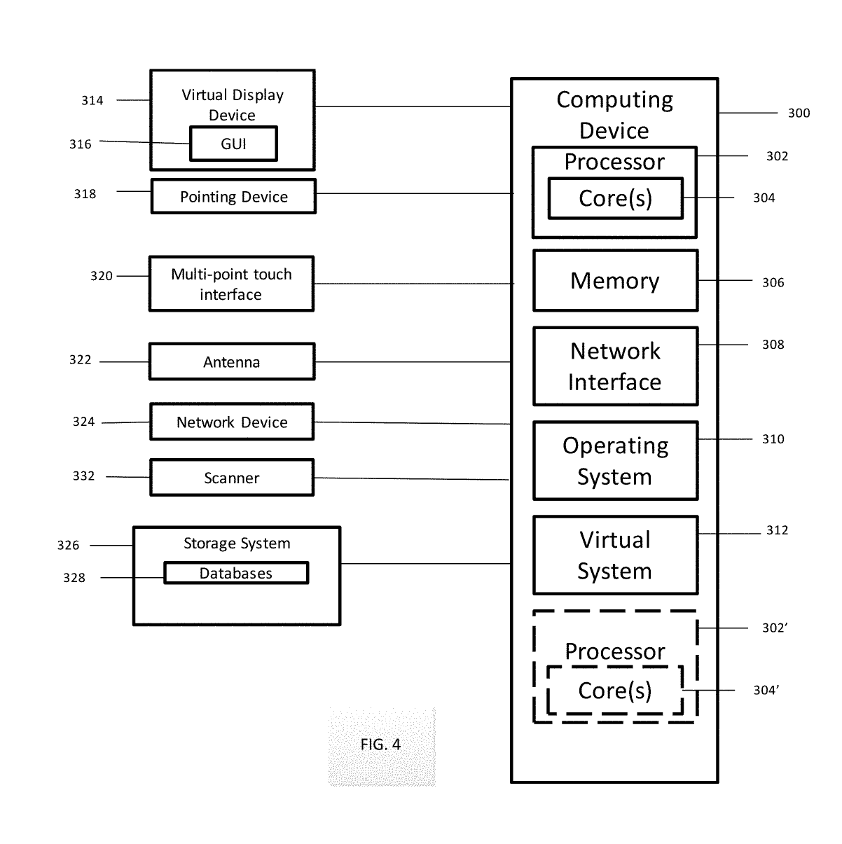

FIG. 4 is a block diagram of an exemplary computing device 400 for implementing an exemplary embodiment. Computing device 400 may be a mobile user device (e.g. mobile user device 106 as shown in FIG. 1) and/or a computing system (e.g. computing system 102 as shown in FIG. 1). Computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 406 included in computing device 400 may store computer-readable and computer-executable instructions or software (e.g., mobile application 420, optimization module, dimension analysis module, etc.) for implementing exemplary operations of computing device 400. Computing device 400 also includes configurable and/or programmable processor 402 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in memory 406 and other programs for implementing exemplary embodiments of the present disclosure. Processor 402 and processor(s) 402′ may each be a single core processor or multiple core (404 and 404′) processor. Either or both of processor 402 and processor(s) 402′ may be configured to execute one or more of the instructions described in connection with computing device 400.

In some embodiments, virtualization may be employed in computing device 400 so that infrastructure and resources in computing device 400 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof.

A user may interact with computing device 400 through a visual display device 414, such as a computer monitor or a touch screen display, which may display one or more graphical user interfaces 416, multi touch interface 420, a scanner 432, and a pointing device 418.

Computing device 400 may also include one or more storage devices 426, such as a hard-drive, CD-ROM, or other computer readable media, for storing data and computer-readable instructions and/or software that implement exemplary embodiments of the present disclosure (e.g., applications). For example, exemplary storage device 426 may include one or more databases 428 for storing instructions. Databases 428 may be updated manually or automatically at any suitable time to add, delete, and/or update one or more data physical items in the databases. Databases 428 include information such as ordered services database 435. Ordered services database 435 stores information associated with ordered services created by or for one or more users.

Computing device 400 may include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the location-based identification system may include one or more antennas 422 to facilitate wireless communication (e.g., via the network interface) between computing device 400 and a network and/or between computing device 400 and other computing devices. Network interface 408 may include a built-in network adapter, network interface card, PCMCIA network card, card bus network adapter, wireless network adapter, USB network adapter, modem or any other device suitable for interfacing computing device 400 to any type of network capable of communication and performing the operations described herein.

Computing device 400 may run operating system 410, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on computing device 400 and performing the operations described herein. In exemplary embodiments, operating system 410 may be run in native mode or emulated mode. In an exemplary embodiment, operating system 410 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method operations, those elements, components or operations may be replaced with a single element, component or operation. Likewise, a single element, component or operation may be replaced with multiple elements, components or operations that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, types of services and advantages are also within the scope of the present disclosure.

Exemplary flowcharts are provided herein for illustrative purposes and are non-limiting examples of methods. One of ordinary skill in the art will recognize that exemplary methods may include more or fewer operations than those illustrated in the exemplary flowcharts, and that the operations in the exemplary flowcharts may be performed in a different order than the order shown in the illustrative flowcharts.

Portions or all of the embodiments of the present invention may be provided as one or more computer-readable programs or code embodied on or in one or more non-transitory mediums. The mediums may be, but are not limited to a hard disk, a compact disc, a digital versatile disc, ROM, PROM, EPROM, EEPROM, Flash memory, a RAM, or a magnetic tape. In general, the computer-readable programs or code may be implemented in any computing language.

We claim:

1. A computer-based system for determining storage locations for one or more physical items in a facility and displaying the one or more physical items in a storage location using augmented reality, the system comprising:
a first mobile user device including a display and a camera, the first mobile user device configured to execute a dimension analysis module to obtain dimensions of one or more physical items and to capture one or more images of the facility;
a database including dimensions of a plurality of storage locations in a facility and a master item list including an arrangement of physical items in the plurality of storage locations; and
a computing system communicatively coupled to the database and the first mobile user device, the computing system configured to execute an optimization module that when executed:
receives dimensions of the one or more physical items from the first mobile user device;
determines one or more available storage locations for the one or more physical items based on the master item list, the dimensions of the one or more physical items, and the dimensions of the plurality of storage locations;
generates one or more recommended locations for storage of the one or more physical items based on the determination of the one or more available storage locations and pre-defined criteria; and
transmits the one or more recommended storage locations to the first mobile user device, wherein the mobile user device provides an augmented reality display of the one or more physical items at the one or more recommended storage locations within a depiction of the facility created using the one or more images.

2. The system of claim 1, wherein the optimization module when executed:
receives, from the first mobile user device, an acceptance of a recommended location for storage of a physical item from the one or more recommended locations for storage; and
stores the accepted location of the physical item in the master item list.

3. The system of claim 1 wherein the optimization module when executed:
receives a rejection of the one or more recommended locations for storage, and
transmits the one or more recommended locations for storage to a second mobile user device searching for an available storage location to store a physical item.

4. The system of claim 1, wherein the dimensions of the plurality of storage locations includes a height, a width, and a length of each storage location.

5. The system of claim 1, wherein the dimensions of each of the one or more physical items includes a height, a width, and a length.

6. The system of claim 1, wherein the one or more recommended locations for storage includes a storage orientation for the one or more physical items in the one or more recommended locations.

7. The system of claim 1, wherein the first mobile user device is configured to obtain the dimensions of the one or more physical items by at least one of receiving a manual input of the dimensions into first mobile user device, scanning machine readable codes associated with the one or more physical items, and searching a database including dimension sizes of the one or more physical items.

8. The system of claim 1, wherein the first mobile user device further includes a scanner installed on the first mobile user device, the first mobile user device further configured to obtain the dimensions of the one or more physical items by scanning the one or more physical items using the scanner.

9. The system of claim 1, wherein the pre-defined criteria includes historical data of past storage locations for the one or more physical items and a sales history for the one or more physical items.

10. The system of claim 1, wherein the first mobile user device further includes a scanner installed on the first mobile user device, the first mobile user device further configured to scan the facility to obtain dimensions of the plurality of storage locations in the facility.

11. A computer-implemented method for determining storage locations for one or more physical items in a facility and displaying the one or more physical items in a storage location using augmented reality, the method comprising:
obtaining, with a first mobile user device that includes a display and a camera, dimensions of one or more physical items and capturing one or more images of the facility;
receiving, at a computing system the dimensions of the one or more physical items from the first mobile user device, the computing system communicatively coupled to a database that holds dimensions of a plurality of storage locations in the facility and a master item list including an arrangement of physical items in the plurality of storage locations;
determining one or more available storage locations for the one or more physical items with the computing system, the determining based on the master item list, the dimensions of the one or more physical items and the dimensions of the plurality of storage locations;
generating one or more recommended locations for storage of the one or more physical items with the computing system, the generating based on the determination of the one or more available storage locations and pre-defined criteria; and
transmitting the one or more recommended locations from the computing system to the first mobile user device,
wherein the mobile user device provides an augmented reality display of the one or more physical items at the one or more recommended locations within a depiction of the facility created using the one or more images.

12. The method of claim 11, further comprising:
receiving an acceptance of a recommended location for storage of a physical item from the first mobile user device at the computing system; and
storing the accepted location of the physical item in the master item list using the computer system.

13. The method of claim 11, further comprising:
receiving a rejection of the one or more recommended locations for storage by the first mobile user device at the computing system, and
transmitting the one or more recommended locations for storage for which a rejection was received to a second mobile user device that is searching for an available storage location to store a physical item.

14. The method of claim 11, wherein the one or more recommended locations for storage includes a storage orientation for the one or more physical items in the one or more available storage locations.

15. The method of claim 11, further comprising:
obtaining the dimensions of the one or more physical items with the first mobile user device by at least one of receiving a manual input of the dimensions into first mobile user device, scanning machine readable codes associated with the one or more physical items, and searching a database including dimension sizes of the one or more physical items.

16. The method of claim 11, further comprising:
using a scanner installed on the first mobile user device to obtain the dimensions of the physical item by scanning the physical item using the scanner.

17. The method of claim 11, wherein the pre-defined criteria includes historical data of past storage locations for the one or more physical items and a sales history for the one or more physical items.

18. The method of claim 11, the method further comprising:
using a scanner installed on the first mobile user device to scan the facility to obtain dimensions of the plurality of storage locations in the facility.

19. A computer-based system for sharing storage locations for one or more physical items in a facility, the system comprising:
a first mobile user device including a display and a camera, the first mobile user device configured to capture one or more images of the facility;
a second mobile user device including a second display and a second camera, the second mobile user device configured to capture one or more additional images of the facility; and
a computing system communicatively coupled to the first mobile user device and the second mobile user device, the computing system configured to execute an optimization module that when executed:
receives a request for a storage location for one or more first physical items from the first mobile user device, the one or more first physical items having a first dimension;
receives a request for a storage location for one or more second physical items from the second mobile user device, the one or more second physical items having a second dimension;
generates one or more recommended locations for storage of the one or more first physical items;
transmits the one or more recommended locations for storage of the one or more first physical items to the first mobile user device, wherein the first mobile user device provides an augmented reality display of the one or more first physical items at the one or more recommended storage locations within a depiction of the facility created using the one or more images;
receives a rejection of the one or more recommended locations for storage from the first mobile user device;
determines that the first dimensions of the one or more first physical items are substantially similar to the second dimensions of the one or more second physical items; and
transmits the one or more recommended locations for storage to the second mobile user device, wherein the second mobile user device provides an augmented reality display of the one or more second physical items at the one or more recommended storage locations within a depiction of the facility created using the one or more additional images.

20. The system of claim 19, wherein the optimization module when executed determines whether to transmit the one or more recommended locations for storage to the second mobile user device based on pre-defined criteria that includes one of historical location and sales data.
